(19) United States
(12) Patent Application Publication
(10) Pub. No.: US 2023/0360346 A1
(43) Pub. Date: Nov. 9, 2023

(54) SYSTEMS AND METHODS FOR RESPONSIVE AUGMENTED REALITY CONTENT

(71) Applicant: SHOPIFY INC., Ottawa (CA)

(72) Inventor: DANIEL BEAUCHAMP, Toronto (CA)

(21) Appl. No.: 17/847,867

(22) Filed: Jun. 23, 2022

Related U.S. Application Data
(60) Provisional application No. 63/338,924, filed on May 6, 2022.

(51) Int. Cl. G06T 19/20; G06T 19/00; G06Q 30/06

(52) U.S. Cl. CPC G06T 19/20; G06T 19/006; G06Q 30/0643; G06T 2219/2016

(57) ABSTRACT

Once AR content associated with a physical object is generated and displayed on the screen of a user device (e.g., a smartphone), various changes, such as movement or partial occlusion of the object, may affect the user device's view of the object. This may result in glitching or disappearance of the AR content. Additionally, the AR content may hinder a user's view of certain areas of interest of the object. In some embodiments, an intelligently responsive AR system may be implemented. Upon detection of a physical object, the AR system may display a first UI having AR content in a first layout. In response to a change affecting the user device's view of the object, the AR system may display a second UI, having AR content arranged in a second layout. The first and second layouts may be arranged to prevent masking any areas of interest on the object.

The present application claims the benefit under 35 U.S.C § 119(e) of U.S. Provisional Patent Application Ser. No. 63/338,924 filed on May 6, 2022, entitled “Systems and Methods for Responsive Augmented Reality Content”, which is incorporated herein by reference.

### FIELD

The present application relates to augmented reality (AR), and in particular embodiments, to presentation of AR content.

### BACKGROUND

In an augmented reality (AR) system, images of a real-world space surrounding a user device may be captured by a sensor, e.g., a camera on the device. The AR system may generate and present AR content on a display of the user device, the AR content overlaid onto a view of the real-world space.

AR differs from virtual reality (VR). VR relates to the creation of a completely virtual experience, whereas AR maintains at least a portion of the real-world experience, but alters the perception of that real-world experience using virtual content.

### SUMMARY

Systems that create an AR experience for a user upon identifying a physical object face various technical challenges.

AR content may be associated with a physical object located within the real-world space. For example, the physical object could be equipped with an image which acts as a marker recognizable by the AR system, or a designated surface of the object can itself act as a marker. Upon detection of the marker, the AR system may generate AR content associated with the object and overlay the AR content on the object.

Once AR content associated with a physical object has been generated, various factors, such as movement of the user device, and/or movement of the object, and/or partial occlusion of the object, may affect the user device's view of the object. Current AR systems may fail to detect the object continually and accurately in response to such changes, resulting in errors such as glitching or disappearance of the AR content. Further, current AR systems fail to intelligently lay out the AR content in response to such changes, leading to flaws that decrease a user's enjoyment of the AR system. For example, if the AR content involves text and the AR system is configured to overlay the AR content on the object, if the user device is moved far enough away from the object, the AR text may become too small for the user to read and/or interact with. These inadequacies may lead to user frustration. Additionally, AR content generated in response to detecting an object may hinder a user's view of certain areas of the physical object, such as a trademark, label, text, or illustration, that are of interest to the user of the system or to the seller of the object.

Therefore, there is a need for an AR system which dynamically and intelligently lays out AR content in response to changes in the real-world environment and/or in response to how a physical object is presented.

In some embodiments, an intelligently responsive AR system may be implemented to provide an improved AR experience for a user. The system may first detect a physical object in a real-world space surrounding a user device. Upon detection of the object, the AR system may generate and display a first user interface associated with the object, the first user interface having AR content arranged in a first layout. The system may design and implement the first layout in such a way that the AR content is overlaid on the object without masking any areas of interest on the object. A subsequent change in the visual field of the device may affect the user's viewing of the first user interface in a way that constrains the viewing of the first user interface. In response, the AR system may generate and display a different, second user interface, which may include the AR content arranged in a different, second layout. The user's viewing of the first user interface may be affected/constrained by, for example, the object becoming smaller or larger than a defined minimum or maximum size in the device display, the object becoming occluded by another object, the object being rotated or oriented to a different position, etc. The responsive AR system may then build the second interface to account for the change. For example, if the object becomes smaller than a defined size in the device display such that the AR content cannot be comfortably viewed when overlaid on the object, the second user interface may include the AR content no longer overlaid on the object, but rather adjacent to the object. As another example, if the object becomes partially occluded, the AR content may be reconfigured on the object to no longer overlap with the occluding object. Regardless of the type of change, the system may ensure that the second layout is also arranged in such a way as to prevent masking any areas of interest on the object.

In some embodiments, there is provided a computer-implemented method. The method may include a step of detecting an object in a real-world space within a visual field of a device. A view of the real-world space may be captured by a sensor and displayed by the device. The method may further include generating a first user interface associated with the object for display by the device. The first user interface may include first AR content arranged in a first layout. The method may further include, responsive to a change in the visual field of the device introducing a constraint relating to viewing of the first user interface, generating a second user interface associated with the object for display by the device. The second user interface may include second AR content arranged in a second layout different from the first layout.

In some embodiments, the computer-implemented method may include a step of determining an overlay-acceptable region of the object, and the first layout may include the first AR content overlaid on the overlay-acceptable region of the object.

In some embodiments, the second AR content may include at least some of the first AR content.

In some embodiments, the constraint relating to viewing of the first user interface may include a size of the object as displayed on the device being smaller than a defined minimum size. In some embodiments, the first layout may include the first AR content overlaid on the object, and the second layout may include the second AR content not overlaid on the object. In some embodiments, the second layout may further include the second AR content in a collapsed form.

In some embodiments, the constraint relating to viewing of the first user interface may include an occlusion of a portion of the object. The occluded portion of the object may overlap at least some of the first AR content arranged in the first layout. In some embodiments, the second layout may include the second AR content not overlapping the occluded portion of the object.

In some embodiments, the constraint relating to viewing of the first user interface may include a size of the object as displayed on the device being larger than a defined maximum size. In some embodiments, the constraint relating to viewing of the first user interface may include a change in at least one of roll, pitch, or yaw of the object in relation to the device. In some embodiments, detecting the object may include identifying that the object is in one state of a set of defined states, and at least some of the AR content may be associated with the one state.

A system is also disclosed that is configured to perform the methods disclosed herein. For example, the system may include at least one processor to directly perform (or instruct the system to perform) the method steps.

In some embodiments, there is provided a computer readable medium having stored thereon computer-executable instructions that, when executed by a computer, cause the computer to perform operations of the methods disclosed herein. The computer readable medium may be non-transitory.

### BRIEF DESCRIPTION OF THE DRAWINGS

Embodiments will be described, by way of example only, with reference to the accompanying figures wherein:

FIG. 1 is a block diagram illustrating a system for providing intelligently responsive AR content, according to some embodiments;

FIG. 2 illustrates a computer-implemented method, according to some embodiments;

FIG. 3 illustrates a user device displaying a view of a real-world space surrounding the user device, the real-world space including a real-world object, according to some embodiments;

FIG. 4 illustrates the user device of FIG. 3 displaying a first user interface associated with the real-world object, the first user interface including AR content arranged in a first layout, according to some embodiments;

FIGS. 5-12 illustrate the user device of FIG. 3, in response to various changes in the visual field of the device, displaying a second user interface associated with the real-world object, the second user interface including AR content arranged in a second layout, according to some embodiments;

FIG. 13 illustrates the user device of FIG. 3 displaying a first user interface associated with a different real-world object, the first user interface including AR content arranged in a first layout, according to some embodiments;

FIG. 14 is a block diagram of an e-commerce platform, according to some embodiments;

FIG. 15 is an example of a home page of an administrator, according to some embodiments; and

FIG. 16 illustrates the e-commerce platform of FIG. 14, but including an AR engine.

### DETAILED DESCRIPTION

For illustrative purposes, specific embodiments will now be explained in greater detail below in conjunction with the figures.

AR is becoming more prevalent as the technology behind it becomes more sophisticated and affordable. AR applications may be applied to many different industries, and can enhance and enrich a user's experience. For example, a user's mobile device such as a phone or a tablet may be used to overlay AR content associated with a detected real-world object so that it appears as if the AR content is actually in the real-world environment within the display screen of the device. The real-world object may be detected by using various methods, such as marker-based AR technology. The user may use functionalities provided by an interface of the device, to interact with the AR content in various ways.

Systems that create an AR experience for a user upon detecting a physical object face various technical challenges.

Once AR content associated with a physical object has been generated, various factors may affect the user device's view of the object. For example, the user device may move as the user moves, and/or the object may move or be moved, and/or the object may become partially occluded by another object. The user may also be able to manipulate certain parameters on the user device to impact the view of the object, such as zooming in or zooming out.

Current AR systems may fail to detect the object continually and accurately in response to such changes, resulting in errors such as glitching or disappearance of the AR content. For example, in systems which implement marker-based AR, the AR content generated upon detection of a marker is displayed only for as long as the sensor can fully detect the marker. If the marker is no longer detectable in full, for example because part of the marker becomes occluded by another object, or the object is moved in some way so that the marker is no longer fully visible, or the marker becomes too small for the sensor to recognize, the AR system may fail to recognize the marker and the AR content simply disappears from the device display.

Further, current AR systems fail to intelligently lay out the AR content in response to such changes, leading to flaws that decrease a user's enjoyment of the AR system. For example, if the AR content involves text and the AR system is configured to overlay the AR content on the object, if the user device is moved far enough away from the object, the AR text may become too small for the user to read and/or interact with. These inadequacies may lead to user frustration.

Additionally, AR content generated in response to detecting an object may hinder a user's view of certain areas of the physical object that are of interest to the user of the system or to the seller of the object. For example, the object may present information in the form of text, diagrams, etc. which the user wishes to continue viewing, or which the seller wishes the user to continually view, despite any AR content. Examples of such information may be a brand logo, a product name, a safety warning, ingredients or materials that make up the object, etc.

For marker-based AR systems, an additional problem is presented if the marker is altered in any way, as the system will no longer recognize it as a marker and no AR content will be generated for display. For example, if the marker is the front-side packaging of a product, a new marker would have to be generated and stored for any variation in the packaging, such as a change in any text or illustration, and the AR system would require re-training for each new marker. This may be time and effort consuming for industries where the packaging is constantly being re-thought and updated.

In some embodiments, an intelligently responsive AR system may be implemented to provide an improved AR experience for a user, as described in detail below.

Although the examples described herein are primarily in the context of e-commerce, the methods and systems are not limited to e-commerce, and may apply to any scenario in which a user is interacting with AR content.

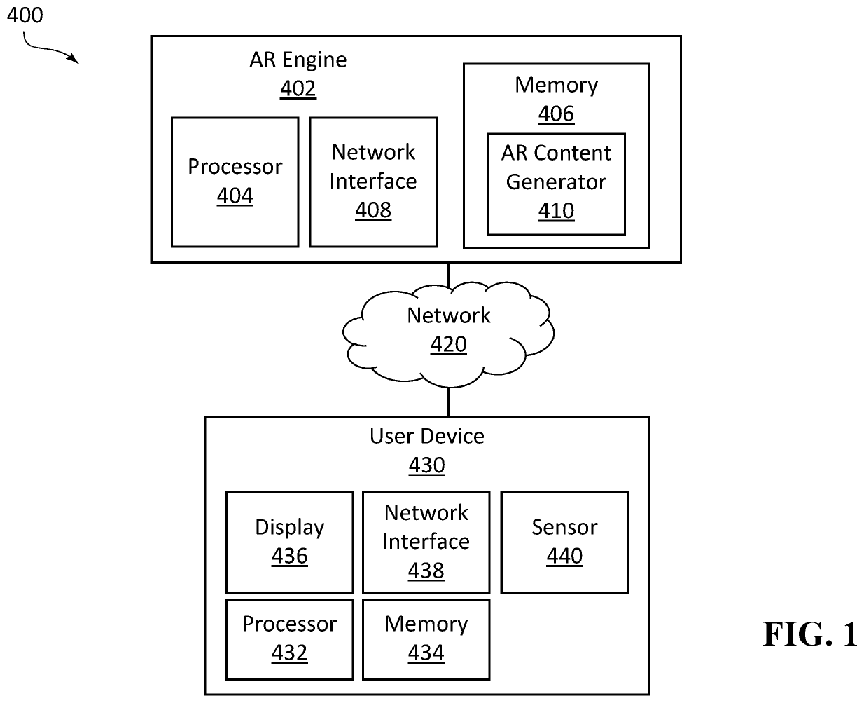

FIG. 1 is a block diagram illustrating an example AR system 400 for providing intelligently responsive AR content, according to some embodiments. The system 400 includes an AR engine 402, a network 420, and a user device 430.

The network 420 may be a computer network implementing wired and/or wireless connections between different devices, including the AR engine 402 and the user device 430. The network 420 may implement any communication protocol known in the art. Non-limiting examples of network 420 include a local area network (LAN), a wireless LAN, an internet protocol (IP) network, and a cellular network.

The AR engine 402 supports the generation of intelligently responsive AR content. As illustrated, the AR engine 402 includes a processor 404, a memory 406, and a network interface 408.

The processor 404 may be implemented by one or more processors that execute instructions stored in the memory 406 or in another non-transitory computer readable medium. Alternatively, some or all of the processor 404 may be implemented using dedicated circuitry, such as an application specific integrated circuit (ASIC), a graphics processing unit (GPU) or a programmed field programmable gate array (FPGA).

The memory 406 includes an AR content generator 410. The memory 406 may store instructions related to the AR content generator 410 that are executed by the processor 404 of AR engine 402. For example, the AR content generator 410 may store instructions and algorithms for creating AR content for display by a user device, and memory 406 may store other instructions related to implementing an AR experience, such as intelligently laying out AR content associated with a real-world object. These instructions may be executed by processor 404.

The network interface 408 is provided for communication over the network 420. The structure of the network interface 408 is implementation specific. For example, the network interface 408 may include a network interface card (NIC), a computer port (e.g., a physical outlet to which a plug or cable connects), and/or a network socket.

The user device 430 includes a processor 432, a memory 434, display 436, network interface 438 and sensor 440. Although only one user device 430 is illustrated in FIG. 1 for sake of clarity, AR engine 402 may interact with other user devices.

Display 436 can present to a user a real-world space as captured by a sensor, such as sensor 440, and can additionally present visual virtual content to a user. Although not shown, user device 430 also includes an interface for providing input, such as a touch-sensitive element on the display 436, a button provided on user device 430, a keyboard, a mouse, etc. The interface may also include a gesture recognition system, a speaker, headphones, a microphone, and/or haptics. The interface may also provide output associated with the visual virtual content on the display 436, e.g. haptic and/or audio content. The display 436 may incorporate elements for providing haptic and/or audio content.

The network interface 438 is provided for communicating over the network 420. The structure of the network interface 438 will depend on how user device 430 interfaces with the network 420. For example, if user device 430 is a wireless device such as a mobile phone, headset or tablet, then the network interface 438 may include a transmitter/receiver with an antenna to send and receive wireless transmissions to/from the network 420. If the user device is a personal computer connected to the network with a network cable, then the network interface 438 may include, for example, a NIC, a computer port, and/or a network socket.

The sensor 440 may be provided to obtain measurements of the real-world space surrounding the user device 430. These measurements can be used to generate representations of the real-world space within which AR content created by AR content generator 410 can be placed. The sensor 440 may additionally capture or detect movements performed by a user in the real-world space surrounding the user device 430, such as a hand action, motion or gesture. The sensor 440 may include one or more cameras, and/or one or more radar sensors, and/or one or more lidar sensors, and/or one or more sonar sensors, and/or one or more gyro sensors, and/or one or more accelerometers, etc. When the sensor 440 includes a camera, images captured by the camera may be processed by the AR engine 402. Measurements obtained from other sensors of the user device 430 such as radar sensors, lidar sensors and/or sonar sensors, can also be processed by the AR engine 402. Although the sensor 440 is shown as a component of the user device 430, the sensor 440 may also or instead be implemented separately from the user device 430 and may communicate with the user device 430 and/or the AR engine 402 via wired and/or wireless connections, for example.

The processor 432 directly performs or instructs all of the operations performed by the user device 430. Examples of these operations include processing inputs received from the user interface 436 and sensor 440, preparing information for transmission over the network 420, processing data received over the network 420, and instructing the display 436 to display a real-world space captured by a camera and to display AR content overlaid onto the view of the real-world space with a particular layout. The processor 432 may be implemented by one or more processors that execute instructions stored in the memory 434 or in another non-transitory computer readable medium. Alternatively, some or all of the processor 432 may be implemented using dedicated circuitry, such as an ASIC, a GPU, or a programmed FPGA.

The AR engine 402 is provided by way of example. Other implementations of an AR engine are also contemplated. In some embodiments, an AR engine may be implemented as a stand-alone service to generate AR content. In some embodiments, an AR engine may be implemented at least in part by a user device and/or on a server associated with the user. For example, AR engine 402 could instead be implemented in part or in whole on the user device 430. A software application may be installed on the user device 430 that generates virtual content locally (i.e., on the user device 430). The software application may receive the AR content generator 410 and/or or any other data stored in memory 406 from the AR engine 402. In some embodiments, an AR engine may be provided at least in part by an e-commerce platform, either as a core function of the e-commerce platform or as an application or service supported by or communicating with the e-commerce platform.

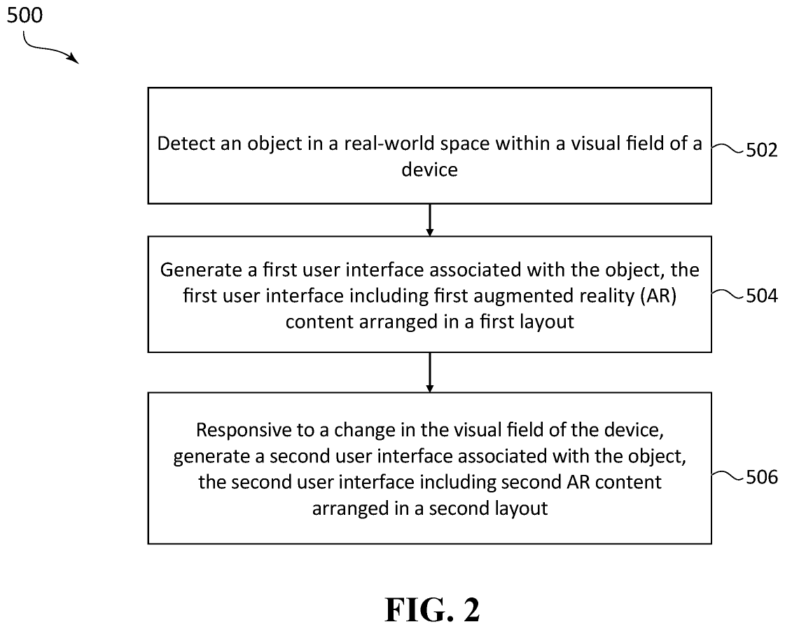

FIG. 2 illustrates a computer-implemented method 500, according to some embodiments. The steps of method 500 are described as being performed by the processor 404 of AR engine 402 of FIG. 1, but this is only an example. At least a portion or all of the method 500 may instead be performed elsewhere, such as at the user device 430.

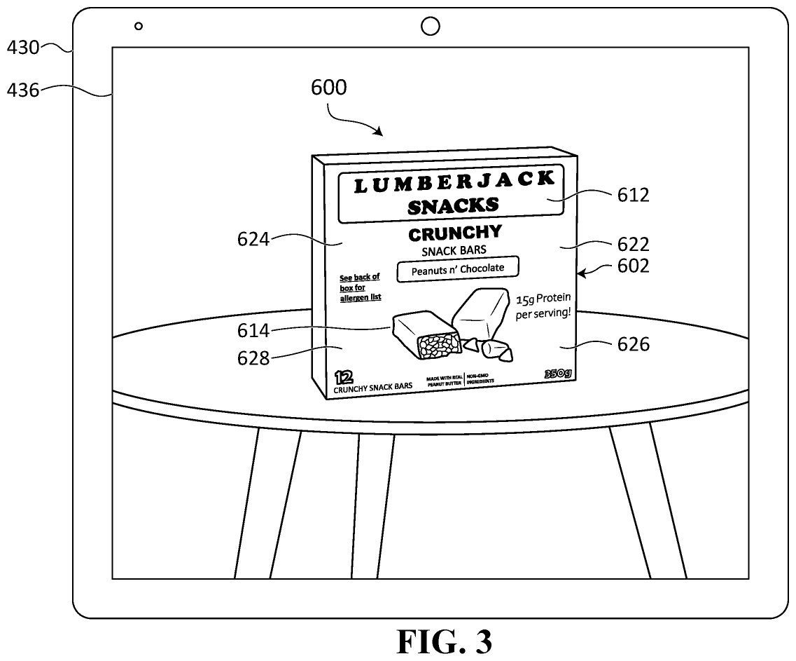

At step 502, processor 404 may detect an object in a real-world space within a visual field of a device. A view of the real-world space may be captured by a sensor and displayed by the device. For example, FIG. 3 illustrates user device 430 with display 436. User device 430 displays, through display 436, a view of the real-world space surrounding user device 430, as captured by sensor 440 (not shown). At any given time, the portion of the real-world space captured by the sensor 440 and displayed to the user on display 436 may be considered as the visual field of the user device 430 at that time. Sensor 440 may include an imaging sensor such as a rear-facing camera on the user device 430 for capturing images of the real-world space, and possibly also a lidar, radar, sonar, or other sensor which can measure the distance between the user device 430 and any point or points of the real-world space captured by the sensor 440. The real-world space includes a real-world object 600 which is detected by processor 404. The terms “physical object” and “real-world object” may be used interchangeably.

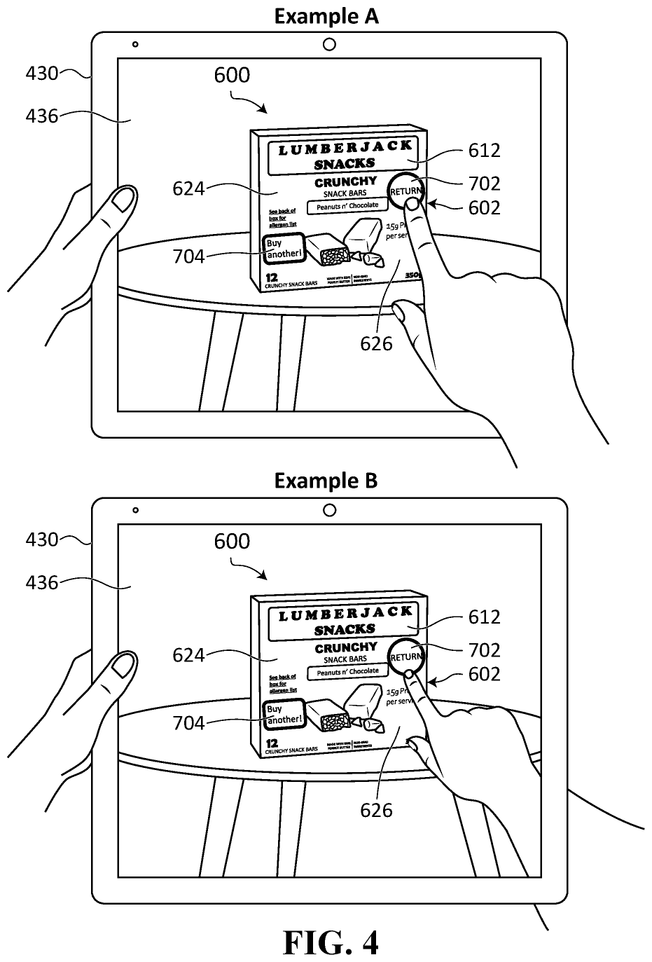

Returning to FIG. 2, at step 504, processor 404 may generate a first user interface for display by the device, the first user interface associated with the object and including first AR content arranged in a first layout. The first user interface may be a graphical user interface (GUI) that displays the first AR content overlaid onto a view of the real-world space. For example, FIG. 4 illustrates an embodiment in which a first user interface has been generated for display by user device 430. The first user interface is associated with the real-world object 600 and includes first AR content. The first AR content includes first and second AR elements 702, 704 arranged in a first layout. Specifically, as illustrated, the first layout may include first and second AR elements 702, 704 overlaid onto a surface of the real-world object 600 in such a way that the AR elements 702, 704 do not overlap, or overlap as minimally as possible, with any content displayed on the object's surface, such as a logo, a label, or any other text, illustration, etc. In other words, the first layout may include the first AR content overlaid onto overlay-acceptable region(s) on the surface of the real-world object 600, the overlay-acceptable region(s) on the object 600 determined by the processor 404.

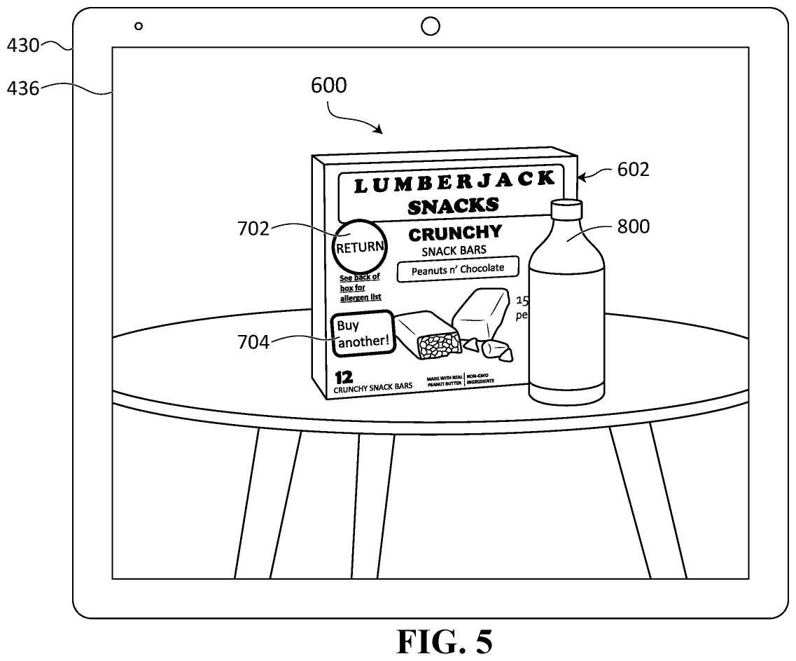

Returning to FIG. 2, at step 506, processor 404 may, responsive to a change in the visual field of the device, generate a second user interface for display by the device, the second user interface associated with the object and including second AR content arranged in a second layout. The second user interface may be a GUI that displays the second AR content overlaid onto a view of the real-world space. The change that occurs in the visual field of the device may be one that introduces a constraint relating to viewing of the first user interface. FIGS. 5-12 illustrate embodiments in which various changes have occurred in the visual field of the device, these changes introducing constraints relating to viewing of the first user interface and prompting the generation of a second user interface for display by the user device 430. For example, in FIG. 5, a second real-world object 800 is shown on the display 436 as occluding a portion of the real-world object 600 and additionally the portion of the real-world object 600 on which the first AR element 702 is overlaid in the first layout. This partial occlusion is an example of a constraint relating to viewing of the first user interface.

The second AR content may include at least some of the first AR content. For example, in FIG. 5, the second AR content includes the same first and second AR elements 702, 704 as the first AR content, although arranged in a different, second layout.

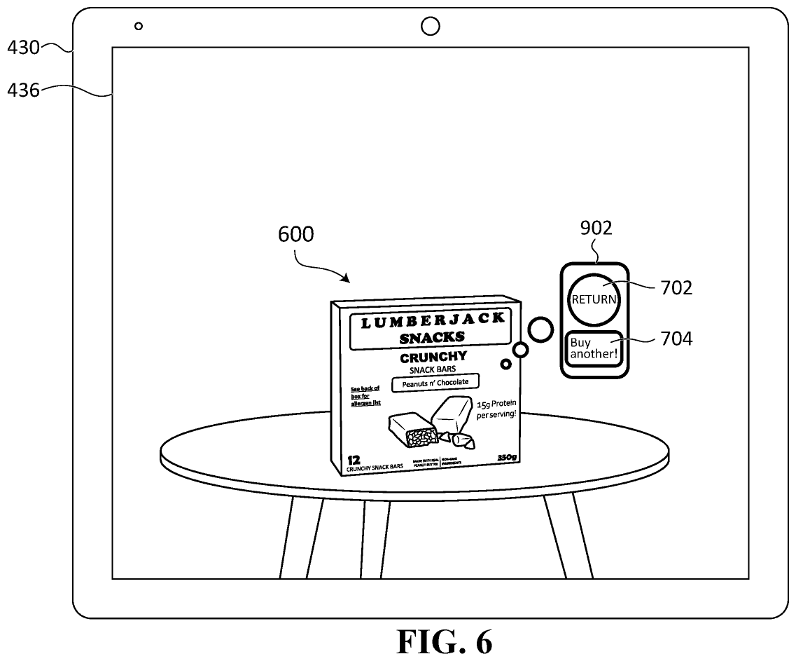

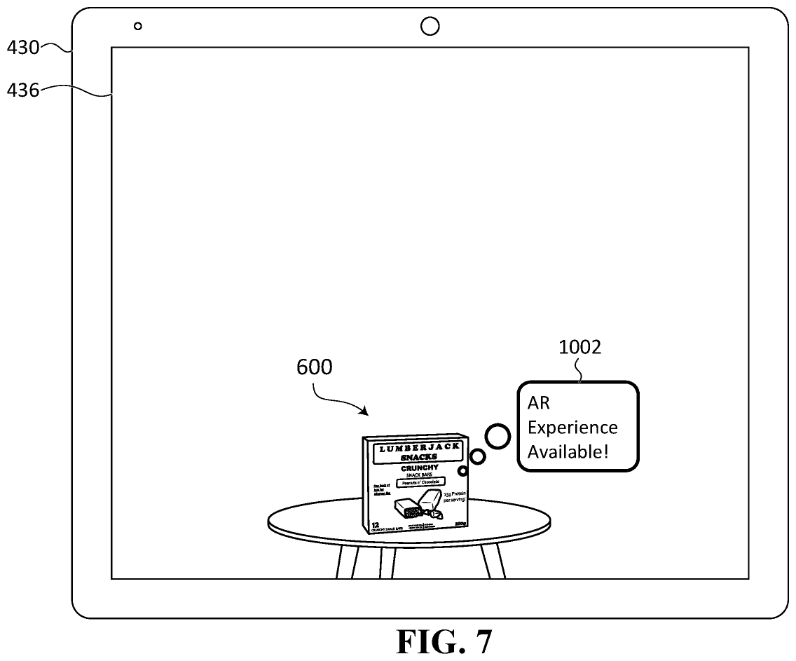

The arrangement of the second layout may be dependent on the nature of the change that introduces a particular constraint affecting viewing of the first user interface. For example, FIGS. 6 and 7 illustrate embodiments where the constraint includes the size of the real-world object 600 as displayed on the user device 430 being smaller than certain defined sizes. In response to the size of the real-world object 600 as displayed on the user device 430 becoming smaller than a first or second defined size, FIGS. 6 and 7 show that the second layout of the second user interface includes the second AR content no longer overlaid on the real-world object 600.

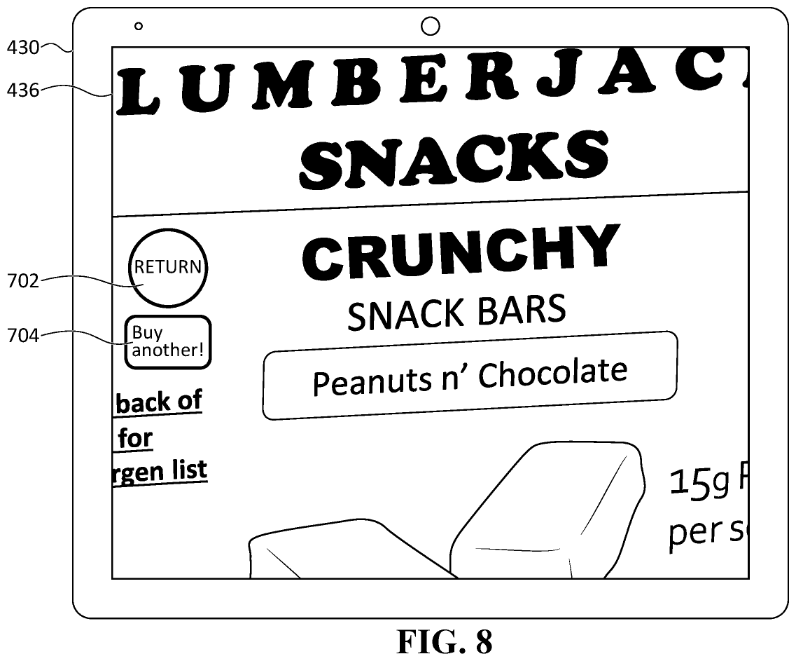

As another example, FIG. 8 shows an embodiment where the constraint includes the size of the real-world object 600 as displayed on the user device 430 being larger than a defined maximum size. In response to this constraint, the second layout is arranged such that first and second AR elements 702, 704 are still overlaid on the real-world object 600 but on a different portion of the real-world object 600, in different positions relative to each other, and in different sizes relative to the size of the real-world object 600 as displayed by user device 430, as compared to the first and second AR elements 702, 704 in the first layout.

As discussed above, in some embodiments, an AR system may detect an object in a real-world space and display AR content that is associated with the object on a user device. A view of the real-world space surrounding the user device may be shown on the user device. For example, FIG. 3 illustrates AR system 400 using a user device 430 to display a view of a real-world space surrounding the user device 430. Images of the real-world space may be captured by a sensor (not shown), such as a rear-facing camera, of the user device 430 and displayed on display 436 of the user device, which may include a touch screen. The real-world space includes a real-world object 600.

In the example illustrated in FIG. 3, real-world object 600 is depicted as being a food product box having six surfaces, with a front surface 602 being the most clearly visible in the visual field of the user device 430. As shown, the front surface 602 includes a logo 612, an illustration 614, and other information related to the food products contained within the product box.

Real-world object 600 may be detected by AR engine 402 of AR system 400 as an object for which associated AR content can be generated and displayed by the user device 430. The AR engine 402 may be accessible through an application on the user device 430. Detection of the real-world object 600 may occur in various ways, such as using marker-based technology, or feature-based technology.

Using marker-based technology to detect a real-world object and generate AR content associated with the real-world object may generally proceed as follows. A static image, also known as a marker, may be created and stored in memory 406 of the AR engine 402. The front surface 602 of the real-world object 600 is an example of a static image that can be stored as a marker. The marker may have certain requirements in order to be recognizable by the AR system 400 as a marker. For example, in most marker-based applications, the marker must be larger than a minimum size and must wholly remain within the visual field of the device at all times. Once the marker is stored in memory 406, the marker can be scanned using the sensor 440, which may include a rear-facing camera, of user device 430. The AR system 400 may be programmed to generate, upon detection of the marker, AR content associated with the marker. Marker-based AR technology possesses several drawbacks, as discussed above.

Alternatively or additionally, feature-based AR technology may be implemented by AR system 400. In using feature-based technology, AR system 400 may be able to detect the real-world object 600 using features found in the real-world object, without the use of a marker. Using feature-based technology to generate AR content associated with the real-world object 600 may generally proceed as follows. During an offline training stage, AR system 400 may be trained to extract feature points from a database of images and store their locations and visualizing descriptors in memory 406 of AR engine 402. Feature points may be corners, edges, blobs, etc. Then, AR engine 402 may implement keypoint detection, e.g., using a Features from Accelerated Segment Test (FAST) corner detector, to calculate feature points from the images of the real-world space surrounding the user device 430 captured by the sensor 440, which may include a rear-facing camera. The feature points extracted from images of the real-world space may be matched to the features stored in memory 406 to detect the real-world object 600. AR systems using feature-based AR may only be able to detect a real-world object of interest as long as the relevant features are identifiable and matchable to features stored in memory. Upon detection of a real-world object, the AR system 400 may be programmed to generate AR content associated with the real-world object.

In some embodiments, AR system 400 may, in addition to implementing marker-based AR and/or feature-based AR processes, use the notion of object permanence. Specifically, using object permanence technology, AR system 400 may be able to maintain its detection of real-world object 600 despite various changes that occur in the visual field of the user device 430 with respect to real-world object 600, which affect a user's viewing of the first user interface. These various changes may be ones that lead to detection failure of the real-world object in AR systems using only marker-based or feature-based AR technology. Examples of such changes include occlusion of the real-world object 600, a change in size of the real-world object 600 as displayed by the user device 430, and a change in at least one of roll, pitch, or yaw of the real-world object 600 in relation to the user device 430. In response, AR system 400 may generate a second user interface to intelligently lay out second AR content in response to such changes.

AR system 400 may track the real-world object 600 using object permanence through machine learning, deep learning, and/or by implementing CenterTrack, PermaTrack, or other software frameworks. For example, memory 402 of AR engine 402 may include a spatial-temporal recurrent memory module, developed and trained using machine learning. This memory module may allow the AR system 400 to use previous images of the real-world space captured by the sensor 440 to reason about the location and identity of the real-world object 600 even as the real-world object undergoes the types of changes mentioned above, which commonly lead to a failure to identify the real-world object 600 as being the real-world object 600.

Upon detecting the real-world object 600 as an object for which associated AR content can be generated, the AR system 400 may determine overlay-acceptable regions of the front surface 602. This may occur using computer vision, machine learning, etc. For example, using computer vision, one or more images captured by an imaging sensor, such as a rear-facing camera of user device 430, may be analyzed to classify the pixels of an image into classes such as “text,” “illustration,” and “background”. Overlay-acceptable regions of the front surface 602 may be defined by those portions of the surface 602 which mostly have pixels classified as “background” pixels. Conversely, non-overlay-acceptable regions of the front surface 602 may be defined by those portions which have mostly pixels classified as “text” or “illustration” pixels. In the embodiment shown by FIG. 3, there may be first, second, third, and fourth portions 622, 624, 626, and 628, respectively, of the front surface 602 which are each determined by AR system 400 to be an overlay-acceptable region due to the prevalence of “background” pixels, i.e. pixels that contain no text, illustration, or other information.

In instances where the detected real-world object does not have portions which can easily be determined to define overlay-acceptable regions, e.g., if the real-world object has some type of information, like text or illustration, on most or all portions of the object, AR system 400 may use different techniques to designate overlay-acceptable regions. For example, the AR system 400 may use computer vision to look for the least visually cluttered portions to deem as overlay-acceptable regions. As another example, the AR system 400 may determine that some types of information, such as a trademark or allergen information, are more important than other types of information, and may thus choose portions containing the less important types of information as overlay-acceptable regions. Certain types of information may be more important than other types of information from the perspective of the seller of the real-world object, the buyer of the real-world object, or both. The AR system 400 may be trained using machine learning to differentiate between the different types of information. Alternatively, the AR system 400 may instead determine that the real-world object does not have overlay-acceptable regions, and therefore the first user interface may include first AR content overlaid some place near, but not on, the real-world object.

FIG. 4 shows the user device 430 displaying a first user interface associated with the real-world object 600, and two examples of the user interacting with the first user interface, according to some embodiments. The first user interface may include first AR content arranged in a first layout. As shown in both Example A and B of FIG. 4, the first AR content includes first AR element 702 and second AR element 704. Each of the first and second AR elements 702, 704 is overlaid on an overlay-acceptable region of the front surface 602 of real-world object 600. Specifically, the first AR element 702 is overlaid on first portion 622, which defines an overlay-acceptable region of the front surface 602, and the second AR element 704 is overlaid on fourth portion 628 also defining an overlay-acceptable region of the front surface 602.

As shown, first and second AR elements 702, 704 are user interface controls with which users may interact, for example with clicking or tapping motions. In more exact terms, an action performed by a user, such as clicking or tapping, may be received by the user device 430 as input associated with an AR element such as first and second AR elements 702, 704. The input may define an operation for information related to the AR element to be displayed on the user device 430. For example, as illustrated by Example A of FIG. 4, the AR elements 702, 704 may be engaged by using a touch-based control of the user device 430, such as a touch screen on display 436. Alternatively or additionally, the AR elements 702, 704 may be engaged using gestures (e.g., a tapping or clicking gesture) performed by the user in the real-world space displayed by the user device 430, as illustrated by Example B of FIG. 4 and which is discussed in more detail below. Once either of the AR elements 702, 704 is engaged by the user, e.g., by tapping it using a touch screen equipped on display 436 or by using a hand motion to achieve (visually simulated) physical contact with the AR element, the user device display 436 may provide information to the user, e.g. through text or illustration. For example, once first AR element 702 is engaged, AR system 400 may display information related to returning the object 600, and once second AR element 704 is engaged, AR system 400 may display information related to buying another of the object 600 and/or an object similar to it. The information may be provided in various ways, such as through the generation of additional AR content by AR engine 402, or on a website to which the user has been led by engaging the first AR element 702 or the second AR element 704.

In some embodiments, a partial occlusion of the real-world object may occur, affecting a user's viewing of the first user interface. For example, in FIG. 5, a real-world object 800 is shown to partially occlude the real-world object 600 in a way that affects the user's viewing of the first user interface, namely, the user's viewing of first AR element 702. In response to the occlusion caused by the second real-world object 800, AR system 400 may generate a second user interface associated with the real-world object 600. The second user interface may include second AR content arranged in a second layout which is different from the first layout. The second layout replaces the first layout such that the first layout is no longer displayed and instead the second layout is displayed by the user device 430.

The second AR content may include at least some of the first AR content, as shown in the embodiment of FIG. 5 where the second AR content also includes first AR element 702 and second AR element 704. Due to the occlusion by the real-world object 800, AR system 400 may no longer view first and third portions 622, 626 of the front surface 602, which are hidden from the user device 430, as being overlay-acceptable regions for AR content. The AR system 400 may then generate the second user interface so that the second layout includes the first and second AR elements 702, 704 overlaid on any remaining (i.e., still visible) overlay-acceptable regions of the front surface 602, i.e., second and fourth portions 624, 628.

In some embodiments, whether or not the second user interface is generated in response to an occlusion of the real-world object 600 may be dependent on the type of occlusion that has occurred. In some embodiments, the AR system 400 may determine the occlusion as being transient, for example, an occlusion caused by an object or person moving past the user of the AR system 400 in between the user device 430 and the object 600. In such instances, recognizing that the occlusion is temporary, the AR system 400 may retain the first user interface on the display 436. In some embodiments, such as the one depicted in FIG. 5, AR system 400 may determine that the occlusion is non-transient, and the AR system 400 may then generate a second user interface with second AR content arranged in a second layout, to account for the occlusion. In some embodiments, the occlusion may be caused by the user's hand. For example, the user may wish to interact with the first AR element 702 as depicted in Example B of FIG. 4 and may consequently occlude a portion of the real-world object 600 and the first AR element 702. In such instances, AR system 400 may, using computer vision, recognize the occlusion as being the user's hand, and may therefore cause the first user interface to remain displayed on the user device 430.

Determining whether an occlusion is transient or non-transient may involve AR system 400 implementing computer vision, which may involve the following. One or more images captured by an imaging sensor such as a rear-facing camera of user device 430 may be analyzed to isolate the occlusion from the background. For example, subsequent image frames may be compared to detect movement by the occluding object which may be different to any movement in the background. This analysis can be used to recognize the initial presence of the occluding object, and also to determine whether the occluding object is moving or how long the occlusion lasts. For example, if the occluding object is unmoved and the occlusion lasts longer than a defined period of time (e.g., two seconds), the AR system 400 may categorize the occlusion as non-transient, and may respond by generating the second user interface.

Using computer vision to determine that the occlusion is a hand, and therefore does not warrant the generation of the second user interface by AR system 400, may involve the process discussed in the above paragraph, and may additionally involve using skin-color filtering to classify the pixels of an image into one of two classes, namely “hand” and “not hand”. If using skin-color filtering, a process known as edge detection may additionally be performed to identify the edge of the hand, which may include identifying those pixels at which the image brightness has discontinuities. When the boundary of the hand is determined by accurate edge detection, the pixels within that boundary can be detected as the hand.

As discussed previously, in some embodiments, AR content generated by the AR system 400 may be engaged using hand gestures performed by a user in the real-world space displayed by the user device 430. Once the hand of a user has been detected by the AR system 400 using computer vision, the AR system 400 may be able to recognize gestures performed in the real-world space by implementing OpenCV Python, MediaPipe, or other software frameworks. The recognized gestures may be quantized gestures such as a tapping or grabbing gesture, or continuous gestures such as a pressing or holding gesture.

If an occlusion is determined to be a hand, even if the occlusion is categorized as being non-transient the AR system 400 may continue to display the first user interface on the user device 430. Thus, in instances where the user engages with the first user interface, namely the AR element 702 or second AR element 704 arranged in the first layout, by using their hand in the real-world space, AR system 400 may ensure that the first and second AR elements 702, 704 remain in place, thereby avoiding user frustration related to each time the user attempts to interact with the AR elements.

In some embodiments, the AR system 400 may generate a second user interface associated with the real-world object in response to the size of the real-world object as displayed on the user device becoming smaller than a defined minimum size. For example, in FIG. 6, it is evident that the real-world object 600 appears smaller on the display 436 of user device 430 than in the embodiments of FIGS. 3-5. Indeed, the real-world object 600 as displayed on the user device 430 is smaller than a first defined minimum size for the real-world object 600. This may be as a result of the object 600 being moved farther away from the user device 430, and/or the user device 430 being moved farther away from the object 600, and/or the user manipulating certain parameters on the user device 430 to impact the view of the object 600, e.g., “zooming out” by using a pinching motion on a touch screen provided on display 436.

This change in size of the real-world object 600 as displayed by the user device 430 introduces a constraint relating to viewing of the first user interface. Specifically, if the first user interface, including the first AR content, was simply scaled in accordance with the depicted change in size of the real-world object, the first and second AR elements 702, 704 may appear too small on the display 436 for the user to be able to easily interact with or view details of (e.g., the text may become too small to read). Therefore, in response AR system 400 may generate a second user interface which may include second AR content arranged in a second layout, the second layout different from the first layout illustrated in FIG. 4. The second AR content may include at least some of the first AR content such as first and second AR elements 702, 704, and may additionally include a third AR element 902. The third AR element 902 is depicted as a floating bubble in which first and second AR elements 702, 704 are positioned. As shown, the second layout is configured such that third AR element 902 (and therefore first and second AR elements 702, 704) is overlaid adjacent to, not on top of, real-world object 600. This allows for the AR elements 702, 704 to be sized in a way that can still be comfortably seen and easily interacted with by the user.

FIG. 6 shows that in the second layout, the first and second AR elements 702, 704 are collapsed into a condensed form as compared to the first and second AR elements 702, 704 in the first layout, in that the AR elements 702, 704 are possibly smaller and in any case are in a “list” form in the second layout. In some embodiments, the second interface may include at least some of the first AR content in other condensed forms. For example, the second layout may have certain portions of the first AR content hidden from view, or organized into a drill down menu.

At this size as displayed on the user device 430, the real-world object 600 may be too small to be detectable using marker-based and/or feature-based technology as an object for which associated AR content can be generated. Instead, the real-world object 600 may continue to be detected and tracked as a result of object permanence processes implemented by AR system 400, which allows associated AR content to continually be displayed on the user device 430.

The first defined minimum size for the real-world object 600 may be determined by the AR system 400 based on various factors, including a size and/or nature of the AR content to be overlaid, and/or a size of any overlay-acceptable regions of the real-world object 600. For example, in FIG. 4, both first and second AR elements 702, 704 include text. For each of the first and second AR elements 702, 704 the AR system 400 may determine the smallest size the real-world object 600 can appear on the display 436 for each respective overlay-acceptable region to be able to accommodate the AR element. Being able to accommodate the AR element may mean that the AR element can still be viewed by the user, without any overlap (or with minimal overlap) between the AR element and non-overlay-acceptable regions. AR system 400 may determine this by, for example, taking into account the smallest font that can comfortably be viewed on the display 436 by a typical user, the amount of text included in the AR element, the overall shape of the AR element, the space provided within an overlay-acceptable region, etc. In this way, the first defined minimum size may differ between different real-world objects, even if the size of the real-world objects are substantially the same.

The first defined minimum size may alternatively or additionally be determined using the distance between the user device 430 and any point or points of the real-world object 600. For example, user device 430 may include a lidar, radar, sonar, or other sensor which can measure the distance between the user device 430 and any point or points of the real-world object 600. Taking into account the size of the real-world object 600, particularly the size (e.g. width, length) of the front surface 602 of the object 600, AR system 400 may generate the second user interface when the distance between the user device 430 and a designated point or surface of the object 600 measures greater than a defined maximum length.

In some embodiments, the real-world object 600 as displayed on the user device may become smaller than a second defined minimum size, the second defined minimum size being smaller than the first defined minimum size. The second defined minimum size for the real-world object 600 may be determined by the AR system 400 based on various factors similar to the ones discussed above in relation to the first defined minimum size. In instances where the real-world object 600 appears smaller than the second defined minimum size on the display 436, the AR system may generate a second user interface associated with the real-world object 600, an example of which is illustrated in FIG. 7. The second user interface has a fourth AR element 1002. The fourth AR element 1002 may indicate to the user that there is other AR content associated with the real-world object 600 which can be generated for display on the user device 430. If the user engages the fourth AR element 1002, e.g. by tapping it, additional text may be displayed such as “Bring your device closer or zoom in!” to encourage the user to configure the user device 430 in a way that the real-world object appears larger on the display 436 than the second defined minimum size or the first defined minimum size, such that AR content (e.g. first and second AR elements 702, 704) can be viewed on the display 436. In some embodiments, a second interface generated in response to the displayed real-world object 600 becoming smaller than a second defined minimum size, may only be generated if a particular mode is enabled on a user device. For example, user device 430 may allow a user to choose between an enabled mode where the AR system 400 generates a second interface such as the one illustrated in FIG. 7, and a disabled mode where the AR system 400 does not generate a second interface, in response to a real-world object becoming smaller on the display 436 than a second defined minimum size. When the mode is enabled, the user may be able to see a second user interface, such as the one shown in FIG. 7, for any real-world object within the visual field of user device 430 which is detected as an object for which associated AR content can be generated. When the mode is disabled, the user device 430 may display no user interface at all when the object as displayed becomes smaller than a second defined minimum size.

In some embodiments, the AR system 400 may generate a second user interface associated with the real-world object in response to the size of the real-world object as displayed on the user device becoming larger than a defined maximum size. For example, FIG. 8 shows an embodiment where the real-world object 600 appears larger on the display 436 than a defined maximum size. This may be as a result of the object 600 being moved closer the user device 430, and/or the user device 430 being moved closer to the object 600, and/or the user manipulating certain parameters on the user device 430 to impact the view of the object 600, e.g., “zooming in” by using an unpinching motion on a touch screen provided on display 436.

This change in size of the real-world object 600 as displayed by the user device 430 introduces a constraint relating to viewing of the first user interface. Specifically, first through fourth portions 622, 624, 626, 628 of the front surface 602 of the real-world object 600 may no longer be wholly visible on the display 436, as shown in FIG. 8. Therefore, if the first user interface, including the first AR content, was simply scaled in accordance with the change in size of the real-world object, the first and second AR elements 702, 704 would appear to be cut off or disappear completely from the display 436. Therefore, in response AR system 400 may generate a second user interface which may include second AR content arranged in a second layout, the second layout different from the first layout illustrated in FIG. 4. The second AR content may include at least some of the first AR content such as first and second AR elements 702, 704. As shown, the second layout is configured such that the first and second AR elements 702, 704 are wholly shown within what remains visible of second portion 624 on the display 436.

It is noted that at this size as displayed on the user device 430, the real-world object 600 may be too large to be detected using marker-based and/or feature-based technology as an object for which associated AR content can be generated. Instead, the real-world object 600 may continue to be detected and tracked as a result of the object permanence processes implemented by AR system 400, which allows associated AR content to continually be displayed on the user device 430.

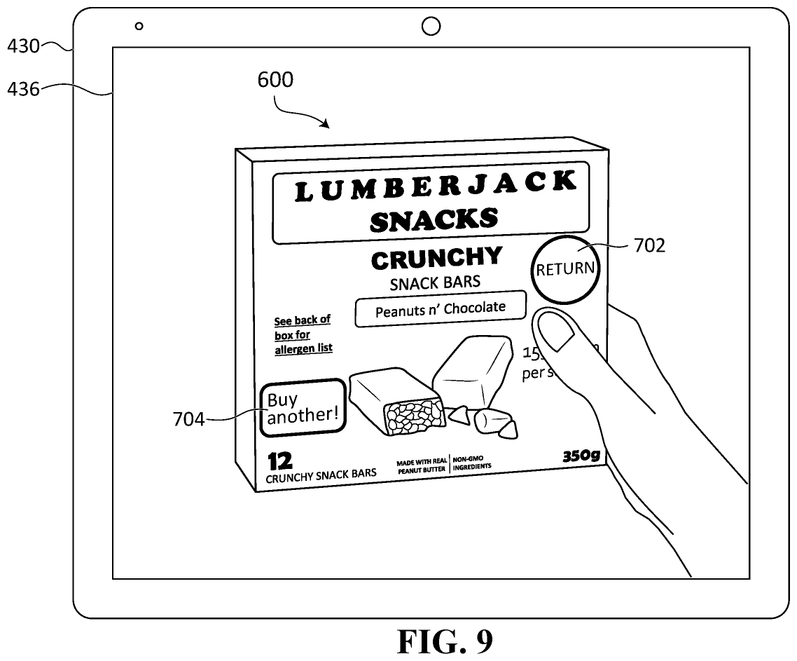

In some embodiments, the AR system 400 may generate a second user interface associated with the real-world object in response to a rotation of the real-world object. For example, FIGS. 9-12 illustrate embodiments in which a user of AR system 400 grabs the real-world object 600 and holds onto the object 600 while altering at least one of roll, pitch, or yaw of the object 600 in relation to the user device 430. In FIG. 9, the user has grabbed the real-world object 600 but has not yet rotated the object 600 in any way as compared to how the object 600 is illustrated in FIG. 4. Therefore, the AR system 400 may retain the first user interface with the first AR content having the first layout on front surface 602. In response to an alteration of at least one of roll, pitch, or yaw of the real-world object 600, AR system 400 may generate a second user interface which may include second AR content arranged in a second layout, the second layout different from the first layout illustrated in FIG. 9.

Regardless of the degree of change in the roll, pitch, or yaw of the real-world object 600, as long as the object 600 remains within the visual field of the user device 430, the AR system 400 may be able to continually detect the object 600 as being the object 600 using object permanence. For example, using computer vision, the AR system 400 may first detect that the user has grabbed the object 600. As long as the object 600 can be tracked, implementing processes related to computer vision and object permanence, within the visual field of the device and there is no subsequent detection of the user's hand letting go of the object 600 (or, e.g., the absence of the user's hand), the AR system 400 may be able to generate a second user interface in response to a change in the roll, pitch, or yaw of the real-world object 600 even if the surface 602 is no longer visible.

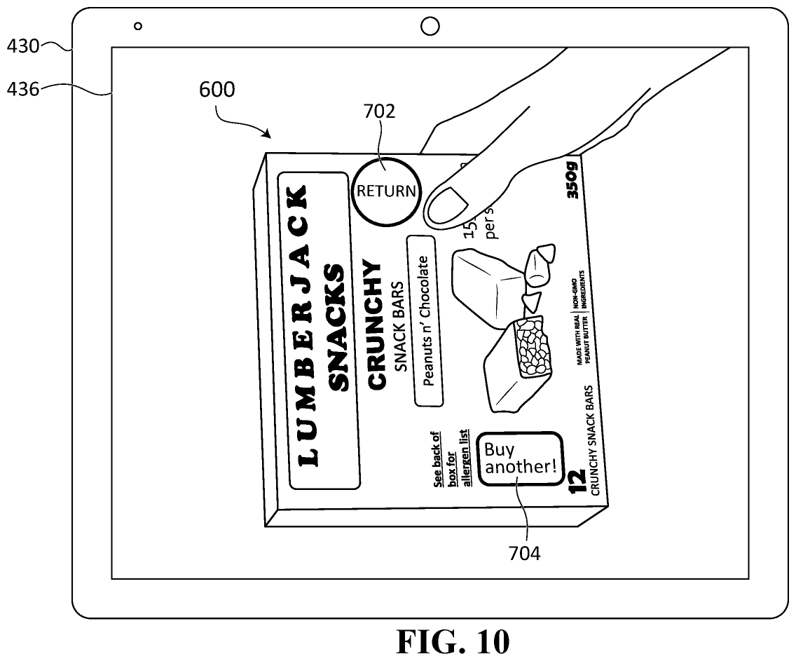

In FIG. 10, the user is shown to have altered the roll of the real-world object 600. The front surface 602 is still the most clearly visible in the visual field of the user device 430 and therefore may be the surface on which the second AR content is overlaid in the second user interface. This change in roll of the real-world object 600 as displayed by the user device 430 introduces a constraint relating to viewing of the first user interface. Specifically, the first layout of the first user interface is arranged such that the text of the first and second AR elements 702, 704 are substantially aligned with the text and illustrations provided on the front surface 602, e.g. in FIG. 9, both the texts in the logo of the real-world object 600 and in the first AR element 702 are substantially upright from the perspective of the user device 430. If the first user interface, including the first AR content, was simply fixed in relation to the front surface 602, the first and second AR elements 702, 704 would appear rotated in accordance with the rotation of the front surface 602, which may make it difficult for the user to comfortably view the AR elements. Therefore, in response AR system 400 may generate a second user interface including second AR content arranged in a second layout. The second AR content may include at least some of the first AR content such as first and second AR elements 702, 704. The second layout may be arranged so that the texts within the first and second AR elements remain substantially upright from the perspective of the user device, and consequently the user.

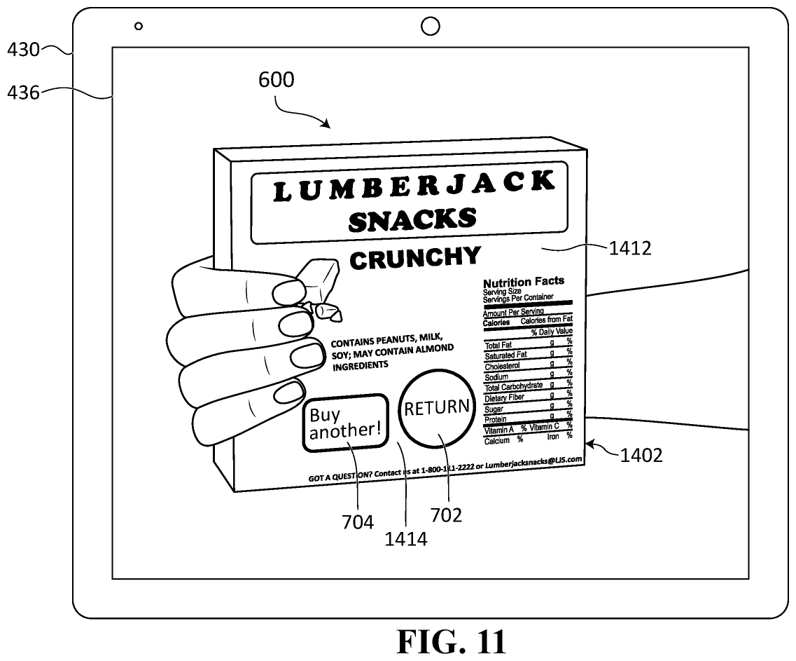

In FIG. 11, the user is shown to have altered the yaw or pitch of the real-world object 600 such that a back surface 1402 of the object 600 is the most clearly visible in the visual field of the user device 430. This change to real-world object 600 as displayed by the user device 430 introduces a constraint relating to viewing of the first user interface. Specifically, if the first user interface, including the first AR content, was fixed in relation to the front surface 602 of the object 600, the first interface and first AR content would disappear from the display 436 when the front surface 602 is no longer visible on the display. The AR system 400 of some embodiments of the present application is instead configured to be intelligently responsive to this change by generating a second user interface having second AR content, where the second AR content is overlaid on the back surface 1402 of the real-world object. The AR system 400 may use the processes discussed previously in relation to determining overlay-acceptable regions, to determine any overlay-acceptable regions on the back surface 1402 of the real-world object 600. For example, the AR system 400 may determine first and second portions 1412, 1414 to define overlay-acceptable regions. The AR system 400 may then generate a second user interface including second AR content arranged in a second layout. The second AR content may include at least some of the first AR content such as first and second AR elements 702, 704 and the second layout may be arranged such that the AR elements 702, 704 are overlaid on overlay-acceptable regions on the back surface 1402. In the embodiment shown in FIG. 11, the overlay-acceptable regions of the back surface 1402 are similar to the overlay-acceptable regions of the front surface 602, in that they contain mostly “background” pixels.

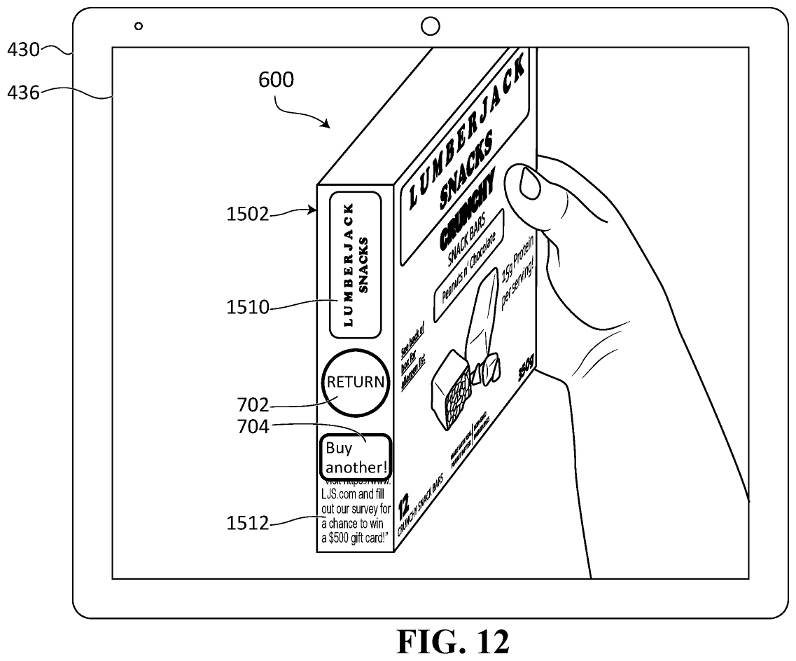

In FIG. 12, the user is shown to have altered the yaw of the real-world object 600 such that a side surface 1502 of the object 600 is the most clearly visible in the visual field of the user device 430. This change to real-world object 600 as displayed by the user device 430 introduces a constraint similar to the one discussed in relation to FIG. 11. The AR system 400 of some embodiments of the present application is configured to be intelligently responsive to this change by generating a second user interface having second AR content, where the second AR content is overlaid on the side surface 1502 of the real-world object. The AR system 400 may use the processes discussed previously in relation to determining overlay-acceptable regions, to determine any overlay-acceptable regions on the side surface 1502 of the real-world object 600. In the embodiment shown in FIG. 12, the side surface 1502 may be provided with a logo 1510 and a text blurb 1512 that provides information about a survey that the user can partake in to potentially win a monetary reward. AR system 400 may determine that there is an overlay-acceptable region between the logo 1510 and text blurb 1512, but that this region is not large enough to accommodate both the first and second AR elements 702, 704 to be a size that can be viewed and interacted with comfortably by the user. Therefore, the AR system 400 may use the processes discussed elsewhere to determine that the text blurb 1512 contains less important information than the logo 1510. The AR system 400 may then generate a second user interface including second AR content arranged in a second layout. The second AR content may include at least some of the first AR content such as first and second AR elements 702, 704, and the second layout may be arranged such that the AR elements 702, 704 are overlaid on the overlay-acceptable regions of the side surface 1502, including over a portion of the text blurb 1512.

As discussed in the embodiments above, AR system 400 may respond to various changes occurring in the visual field of the user device 430 by maintaining its detection of the real-world object 600, and intelligently reconfiguring existing AR content or generating other AR content in a way that minimizes overlap with non-overlay-acceptable regions of the object 600, and allows the AR content to continually be viewed and interacted with easily by the user.

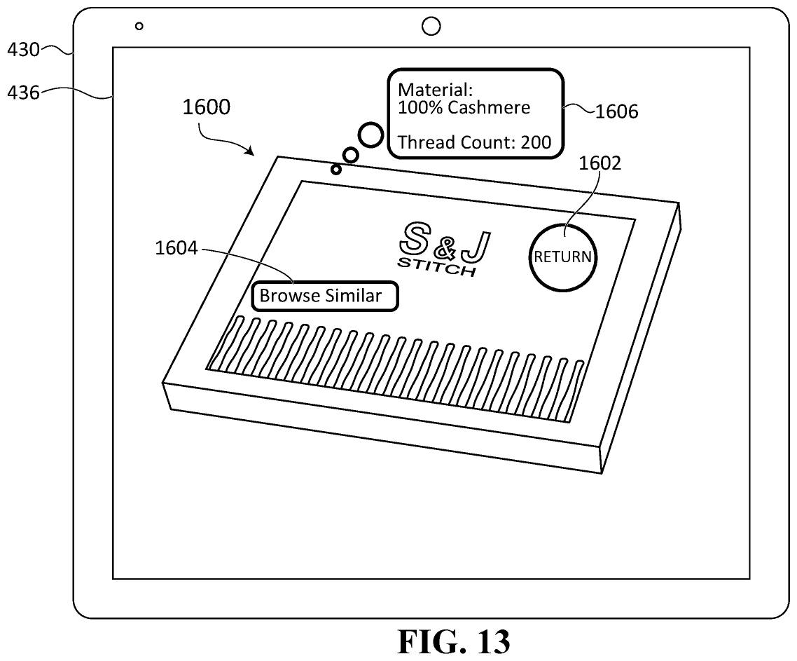

In some embodiments, the generated AR content associated with the detected real-world object and/or the layout of that AR content may be based on one or more features of the real-world object. For example, FIG. 13 illustrates the user device 430 displaying a first user interface associated with a detected real-world object 1600, the first interface including AR content arranged in a first layout. The AR content includes a first AR element 1602 which may display information related to returning the object 1600 when engaged, and a second AR element 1604 which may provide information, e.g. through text or illustration, related to items similar to the object 1600. The AR content additionally includes a third AR element 1606 which may present information based on (e.g. associated with) one or more features of the real-world object 1600, such as the material of the object and the thread count of the object, as shown. The information related to the one or more features of the real-world object 1600 may be detected by the AR system 400 directly, e.g., by using computer vision and/or machine learning, or indirectly based on the identity of the object. For example, the AR system 400 may have data associated with the object stored in memory 406, or may have access, e.g. using network 420, to metadata associated with the 1600, such as when it was purchased, any details related to the product from the seller of the object, etc.

In some embodiments, AR system 400 may be able to determine that the real-world object is in one (or more) state(s), and may generate AR content based on the identified state of the real-world object. The identified state may be one of a set of defined states known to the AR system 400. Examples of such states may include “unopened”, “sealed”, “opened”, “damaged”, “worn”, etc. The AR system 400 may determine the state of the real-world object directly, for example, by using computer vision and/or machine learning to look for features such as an unbroken seal or wrapper, or damage, or wear and tear. Alternatively or additionally, the AR system 400 may be able to determine the state of the real-world object indirectly, for example, using purchase records or other data associated with the real-world object, such as how recently the object was purchased. Depending on the state the real-world object is identified to be in, the associated AR content generated by the AR system 400 may differ, i.e., at least some of the generated AR content may be associated with the identified state. For example, the first AR element 702 in FIGS. 4-6 and 8-12 may have been generated by the AR system 400 as a result of determining that the real-world object 600 was just purchased and/or has not yet been opened. Had the AR system 400 determined that the real-world object 600 had been opened, it may not have generated first AR element 702 but rather another AR element with different text or illustration, for example an AR element related to submitting a review of the real-world object 600. As another example, had the AR system 400 determined that there were signs of wear and tear or damage on the real-world object 600, it may have generated an AR element relating to return policies.

In some embodiments, the generated AR content may also be based on a detected identity of a real-world object. For example, the AR system 400 may identify, using feature-based AR technology and/or computer vision, that real-world object 600 is a food product box containing snack bars for consumption. The AR system 400 may additionally identify the seller of the food product box by analyzing features such as the logo 612, or based on metadata associated with the object, such as a purchase record. The AR content generated by AR system 400 may then be related to the detected identity, e.g. the AR content may include AR elements for viewing different available flavors of the snack bars, browsing similar food products by the same seller, etc.

In some embodiments, A/B testing may be performed to determine the layout of AR content that will be displayed to the user of user device 430. A/B testing refers to a randomized experimentation process wherein two or more versions of a variable are compared by testing the response to each version. The A/B testing or split testing may be used in order to determine how the first layout of the first user interface and/or the second layout of the second user interface should be presented for a particular real-world object. For example, the first layout of the first AR content in FIG. 4 shows the first and second AR elements 702, 704 overlaid on first and fourth portions 622, 628, respectively. Another version of the first layout may include the first and second AR elements 702, 704 overlaid on just the first portion 622, or first and third portions 622, 626, or second and third portions 624, 626, etc. The various versions of the first layout may be displayed to different groups of customers who use the AR system 400 with the real-world object 600. The layout to be presented for the real-world object 600 may be determined by analyzing any positive or negative feedback by users. For example, a version of the first layout having both of the AR elements 702, 704 overlaid on the first portion 622 may result in the first AR element 702 being engaged when the user means to interact with the second AR element 704, and vice versa, due to the proximity of the two AR elements, and may result in decreased user satisfaction. Conversely, a version of the first layout having the first and second AR elements 702, 704 overlaid on first and third portions 622, 626 (which are located on the right side of the front surface 602) may make it relatively easy for a user to engage with both AR elements 702, 704 without conflict, while holding the user device 430 with their left hand and interacting with the AR elements with their right hand, and may result in increased user satisfaction.

An Example e-Commerce Platform

Although integration with a commerce platform is not required, in some embodiments, the methods disclosed herein may be performed on or in association with a commerce platform such as an e-commerce platform. Therefore, an example of a commerce platform will be described.

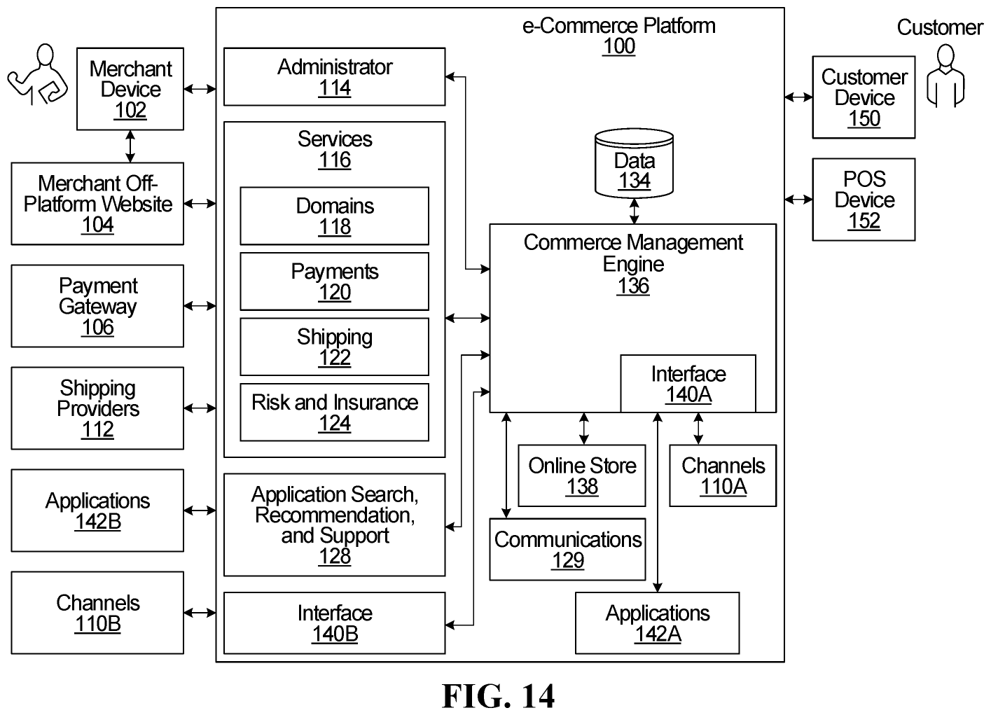

FIG. 14 illustrates an example e-commerce platform 100, according to some embodiments. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 14, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

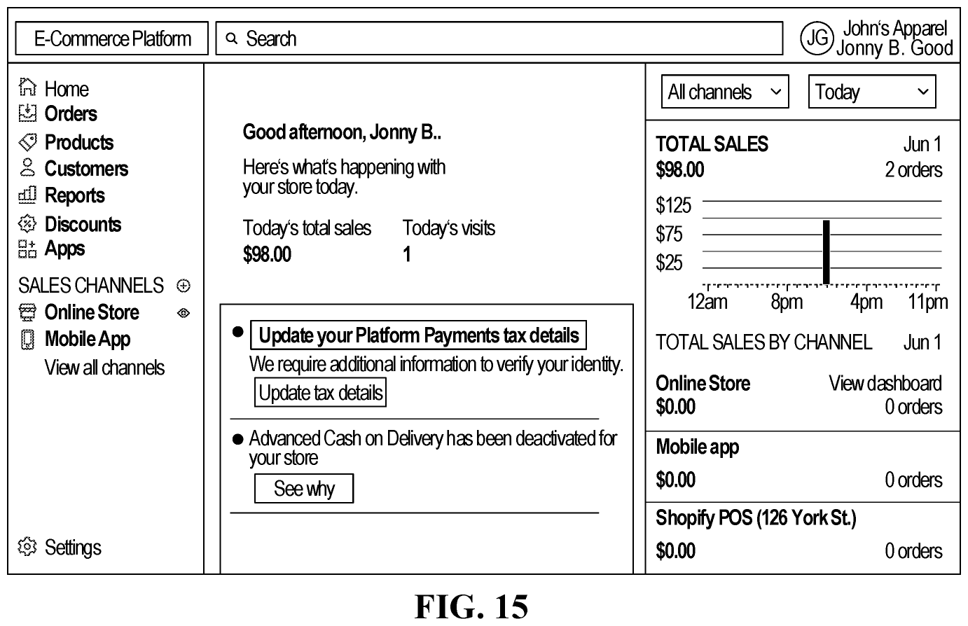

FIG. 15 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 15. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as, for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 14, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In some embodiments, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

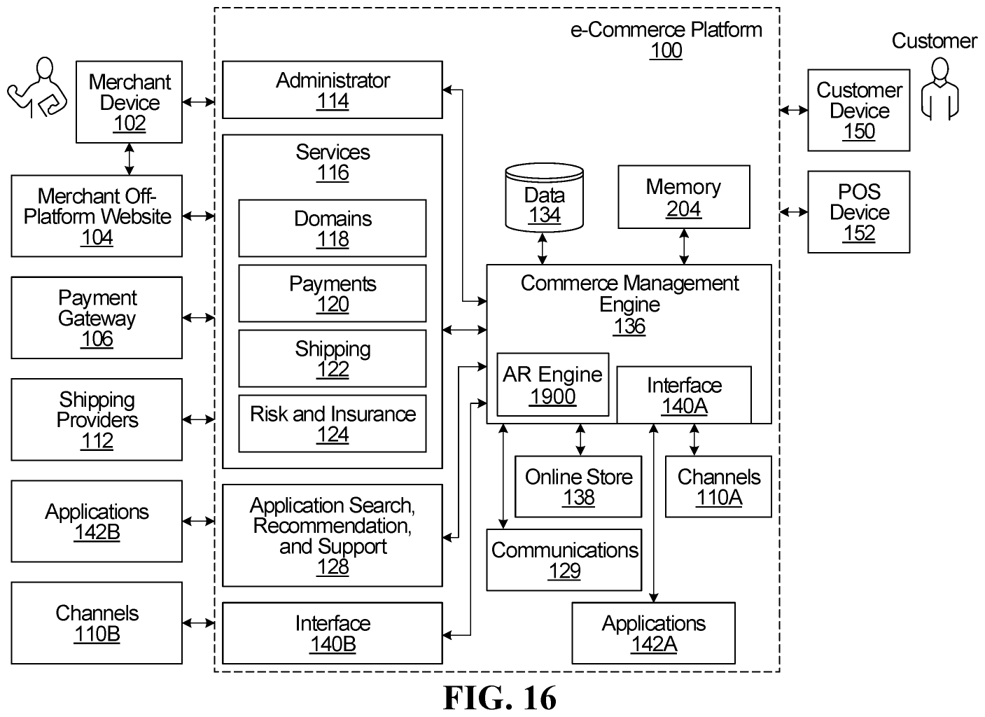

FIG. 16 illustrates the e-commerce platform 100 of FIG. 14, but with the addition of an AR engine 1900 and a memory 204. The AR engine 1900 is an example of a computer-implemented system that generates AR content for use by the e-commerce platform 100, the customer device 150 and/or the merchant device 102. In some embodiments, the AR engine 1900 may be AR engine 402. Although the AR engine 1900 is illustrated as a distinct component of the commerce management engine 136 of e-commerce platform 100 in FIG. 16, this is only an example. An AR engine could also or instead be provided by another component residing within or external to the e-commerce platform 100. In some embodiments, either or both of the applications 142A-B provide an AR engine that is available to customers and/or to merchants. The AR engine 1900 may be implemented by one or more general-purpose processors that execute instructions stored in a memory (e.g. in memory 204) or stored in another computer-readable medium. The instructions, when executed, cause the AR engine 1900 to perform the operations of the AR engine 1900, e.g., the operations described earlier in relation to FIG. 2. Alternatively, some or all of the AR engine 1900 may be implemented using dedicated circuitry, such as an ASIC, a GPU, or a programmed FPGA.

In some embodiments, the e-commerce platform 100 may include multiple AR engines that are provided by one or more parties. The multiple AR engines may be implemented in the same way, in similar ways and/or in distinct ways. In addition, at least a portion of an AR engine may be implemented in the merchant device 102 and/or in the customer device 150. For example, the customer device 150 may store and run an AR engine locally as a software application.

The AR engine 1900 may implement at least some of the functionality described herein. Although the embodiments described above may be implemented in association with an e-commerce platform, such as (but not limited to) the e-commerce platform 100, the embodiments described are not limited to the specific e-commerce platform 100 of FIGS. 14 to 16. Further, the embodiments described herein do not necessarily need to be implemented in association with or involve an e-commerce platform at all. In general, any applications of AR could implement the systems and methods disclosed herein.

### CONCLUSION

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

1. A computer-implemented method comprising:
detecting an object in a real-world space within a visual field of a device, a view of the real-world space captured by a sensor and displayed by the device;
generating a first user interface associated with the object for display by the device, the first user interface including first augmented reality (AR) content arranged in a first layout; and
responsive to a change in the visual field of the device introducing a constraint relating to viewing of the first user interface,
generating a second user interface associated with the object for display by the device, the second user interface including second AR content arranged in a second layout different from the first layout.

2. The computer-implemented method of claim 1 further comprising determining an overlay-acceptable region of the object, wherein the first layout includes the first AR content overlaid on the overlay-acceptable region of the object.

3. The computer-implemented method of claim 1, wherein the second AR content includes at least some of the first AR content.

4. The computer-implemented method of claim 1, wherein the constraint includes a size of the object as displayed on the device is smaller than a defined minimum size.

5. The computer-implemented method of claim 4, wherein the first layout includes the first AR content overlaid on the object, and wherein the second layout includes the second AR content not overlaid on the object.

6. The computer-implemented method of claim 5, wherein the second layout further includes the second AR content in a collapsed form compared to the first AR content.

7. The computer-implemented method of claim 1, wherein the constraint includes an occlusion of a portion of the object, the occluded portion of the object overlapping at least some of the first AR content arranged in the first layout.

8. The computer-implemented method of claim 7, wherein the second layout includes the second AR content not overlapping the occluded portion of the object.

9. The computer-implemented method of claim 1, wherein the constraint includes a size of the object as displayed on the device being larger than a defined maximum size.

10. The computer-implemented method of claim 1, wherein the constraint includes a change in at least one of roll, pitch, or yaw of the object in relation to the device.

11. The computer-implemented method of claim 1, wherein detecting the object includes identifying that the object is in one state of a set of defined states, and wherein at least some of the AR content is associated with the one state.

12. A system comprising:
at least one processor; and
a memory storing processor-executable instructions that, when executed, cause the at least one processor to:
detect an object in a real-world space within a visual field of a device, a view of the real-world space captured by a sensor and displayed by the device;
generate a first user interface associated with the object for display by the device, the first user interface including first augmented reality (AR) content arranged in a first layout; and
responsive to a change in the visual field of the device introducing a constraint relating to viewing of the first user interface,
generate a second user interface associated with the object for display by the device, the second user interface including second AR content arranged in a second layout different from the first layout.

13. The system of claim 12, wherein the at least one processor is further to determine an overlay-acceptable region of the object, and wherein the first layout includes the first AR content overlaid on the overlay-acceptable region of the object.

14. The system of claim 12, wherein the second AR content includes at least some of the first AR content.

15. The system of claim 12, wherein the constraint includes a size of the object as displayed on the device is smaller than a defined minimum size.

16. The system of claim 15, wherein the first layout includes the first AR content overlaid on the object, and wherein the second layout includes the second AR content not overlaid on the object.

17. The system of claim 16, wherein the second layout further includes the second AR content in a collapsed form compared to the first AR content.

18. The system of claim 12, wherein the constraint includes an occlusion of a portion of the object, the occluded portion of the object overlapping at least some of the first AR content arranged in the first layout.

19. The system of claim 18, wherein the second layout includes the second AR content not overlapping the occluded portion of the object.

20. The system of claim 12, wherein the constraint includes a size of the object as displayed on the device being larger than a defined maximum size.

21. The system of claim 12, wherein the constraint includes a change in at least one of roll, pitch, or yaw of the object in relation to the device.

22. A non-transitory computer readable medium having stored thereon computer-executable instructions that, when executed by a computer, cause the computer to perform operations comprising:
detecting an object in a real-world space within a visual field of a device, a view of the real-world space captured by a sensor and displayed by the device;
generating a first user interface associated with the object for display by the device, the first user interface including first augmented reality (AR) content arranged in a first layout; and
responsive to a change in the visual field of the device introducing a constraint relating to viewing of the first user interface,
generating a second user interface associated with the object for display by the device, the second user interface including second AR content arranged in a second layout different from the first layout.
